(19) United States
(12) Patent Application Publication
(10) Pub. No.: US 2015/0267437 A1
(43) Pub. Date: Sep. 24, 2015

(54) Collapsible safety rail system

(71) Applicant: BlueWater Manufacturing LLC, Chaska, MN (US)

(72) Inventors: Gregory S. Kenton, Minnetrista, MN (US); Anthony J. Mertes, Chanhassen, MN (US)

(21) Appl. No.: 14/729,635

(22) Filed: Jun. 3, 2015

Related U.S. Application Data
(63) Continuation of application No. 14/184,414, filed on Feb. 19, 2014.
Application No. 14/184,414 is a division of application No. 11/149,569, filed on Jun. 10, 2005, now Pat. No. 8,689,938.

(51) Int. Cl. E04H 17/14; E06B 11/00; E04H 17/18; E04H 17/22

(52) U.S. Cl. CPC E04H 17/1421; E04H 17/22; E06B 11/00; E04H 17/18; E04H 2017/1447; E04H 2017/1491

(57) ABSTRACT

A collapsible safety rail system for providing a portable or permanent protective barrier to provide for fall prevention from elevated or other work areas. Lockable pivot assemblies are located between heavy bases and the end posts of collapsible safety rail assemblies. Removable detent pins are utilized to lock the pivot assemblies to maintain the erected position of the collapsible safety rail assemblies in protective vertical orientation or are removed to allow maneuvering of the collapsible safety rail assemblies to a minimum viewable profile position when not required for personnel protection.

### CROSS REFERENCE TO RELATED APPLICATIONS

This patent application is a continuation of and claims benefit of U.S. patent application Ser. No. 14/184,414, filed Feb. 19, 2014, which is a divisional of and claims benefit of U.S. patent application Ser. No. 11/149,569, filed Jun. 10, 2005, now U.S. Pat. No. 8,689,938, issued on Apr. 8, 2014, the contents of which are hereby incorporated by reference in their entirety.

### FIELD OF THE INVENTION

This invention pertains to a safety rail system, and more particularly, pertains to a collapsible safety rail system for providing a portable or permanent protective barrier to provide for fall prevention from elevated or other work areas.

### BACKGROUND OF THE INVENTION

The present application is related to application Ser. No. 10/916,688 entitled “Gate Section and Base for a Safety Rail System” filed on Aug. 11, 2004, now U.S. Pat. No. 6,902,153, which is a divisional of application Ser. No. 10/319,992 entitled “Gate Section and Base for Safety Rail System” filed Dec. 16, 2002, now U.S. Pat. No. 6,845,970, which is a continuation-in-part of application Ser. No. 09/595,794 entitled “Safety Rail System” filed Jun. 16, 2000, now U.S. Pat. No. 6,554,257.

Prior art safety rail systems or other fall prevention systems have been provided to prevent workers or other personnel from falling off an elevated work area, such as a rooftop, or to prevent personnel from falling into open work pits. Some fall prevention systems are only used occasionally and the temporary erection of a fall prevention system, such as at the edge of a building roof, can prove to be costly and time consuming. Often, aesthetics require that safety rail/guard rail systems be out of sight or that the systems be completely removed as to not detract from the beauty or aesthetics of a building or other publicly viewed area when not in use. One method of keeping a fall prevention system out of sight is by providing a low profile mounted horizontal lifeline in close proximity to a roof surface. Both ends of a horizontal lifeline are firmly anchored into structure underlying the waterproof region of a roof. A workman then dons a harness having a safety line and attaches the distant end of the safety line to the span of the lifeline to traverse the length of the horizontal lifeline. While being out of sight, the horizontal lifeline offers fall protection; however, a secure and waterproof installation of the horizontal lifeline can be difficult and expensive. Additionally, a horizontal lifeline system is an active fall prevention system requiring that an individual must actively don a harness having a safety line which then must be connected to the span of the horizontal lifeline. If an individual neglects to don the harness and connect the safety line, then the attributes of such an active system are not realized. A passive fall prevention system such as provided by the present invention does not require, after erection of the rails, any further action or connective maneuver by any personnel member. Protection is provided for all personnel, not just those who are connected such as to a lifeline.

### SUMMARY OF THE INVENTION

The general purpose of the present invention is to provide a collapsible safety rail system which is portable and which is intended to be used to provide for fall protection from elevated or other work areas where human safety is an issue. The collapsible safety rail system is a portable system which can be broken down to a plurality of individual collapsible safety rail assemblies and a plurality of heavy and substantial cast iron bases which support the collapsible safety rail assemblies. The collapsible safety rail assemblies include a plurality of rails and end posts where a pivot assembly comprises the lower portion of each end post. Each pivot assembly includes a slotted tubular base which is stationary and a multi-radius mounting fixture pivotably secured to the upper region of the slotted tubular base. A pivot pin secures between an upper region of the slotted tubular base and through a pivot pin hole in a reduced radius shaft portion of the mounting fixture. A detent pin secures between an upper region of the slotted tubular base and through a detent pin hole in the reduced radius shaft portion of the mounting fixture. The lower region of the slotted tubular base aligns and secures within a post receiver in the cast iron base and can be rotated therein. The lower portion of an end post of the collapsible safety rail assembly aligns over and suitably secures about an end post mount at the upper portion of the mounting fixture. The collapsible safety rail assembly can be pivoted horizontally about the pivot pins subsequent to removal of the detent pins to a substantially horizontal and flat orientation, thereby reducing the viewable profile of the collapsible safety rail system and positioning the collapsible safety rail system completely out of view provided that the lower structure of the invention is located on an otherwise nonviewable area.

The bases of substantial weight are vital components of the collapsible safety rail system and enable the system to be as versatile as described herein. A base according to this invention has four post receivers so as to enable as many as four assemblies or devices including the collapsible safety rail assembly, as well as other patented devices by the inventor, such as, but not limited to, rail sections, latching posts, gate posts, or related devices, to be engagingly incorporated at any one time. Designed into each of the post receivers are strategically positioned slots, being horizontally aligned and being elongated. These slots align with at least two spaced holes in the lower region of the end posts of the collapsible safety rail assembly. This alignment enables the safety rail assemblies to be secured to the base at infinite positions along a 360 degree rotation with a locking pin. Thus, the collapsible safety rail system has the versatility to align to multiple protected work areas defined by the base placement. The base also incorporates four symmetrically positioned holes to enable a permanent mount to a surface via some form of anchor bolts, if desired. Further, the base includes cutouts and recesses which form recessed handles for manual grasping when it is necessary to move or carry the base. All edges of the recesses and the upper edges of the cutouts are rounded to eliminate sharp corners that could prove to be uncomfortable when the recessed handles are gripped. Yet another feature of the base is a stacking feature. Specifically, the base includes stacking recesses on its planar bottom surface in alignment with the post receivers. These stacking recesses receive the upper ends of the post receivers for stacking of bases when not in use. Drain holes coaxial with the post receivers and the stacking recesses extend through the base. Although collapsibility and portability of the collapsible safety rail system are major attributes of the invention, provisions are also made for continual use of the invention where the invention can be permanently secured and permanently utilized as a fixed but collapsible structure.

According to one or more embodiments of the present invention, there is provided a collapsible safety rail system which includes one or more collapsible safety rail assemblies having pivot assemblies and a plurality of bases. The pivot assemblies at the lower portions of the collapsible safety rail assemblies allow the collapsible safety rail assemblies to maintain an upright protective position or to allow the collapsible safety rail assemblies to be pivoted about the pivot assemblies to maintain a low and unobtrusive profile. The safety rail assemblies and plurality of substantial heavy bases provide for stability of the collapsible safety rail system to provide a robust structure which denies access to a hazard area or work area which is substantially unmovable when acted upon by any off balance, falling, or misdirected human form.

One significant aspect and feature of the present invention is a collapsible safety rail system incorporated to prevent access to hazardous areas or to prevent falls from roofs or other elevated structures or falls into hazardous areas.

Another significant aspect and feature of the present invention is a collapsible safety rail system which can surround or be located adjacent to a work area.

A further significant aspect and feature of the present invention is collapsible safety rail system having pivot assemblies which allow collapsible safety rail assemblies to be maneuvered to a low profile unobtrusive position.

A still further significant aspect and feature of the present invention is a collapsible safety rail system which, by the use of common bases, can also accommodate other rail sections, latching posts, gate posts, or related devices to be incorporated at any one time.

Still another significant aspect and feature of the present invention is the use of a pivot assembly between a heavy base and an end post of a collapsible safety rail assembly.

Yet another significant aspect and feature of the present invention is a pivot assembly having a slotted tubular base which pivotally accommodates a mounting fixture.

Yet another significant aspect and feature of the present invention is a mounting fixture having an end post mount and a reduced radius shaft.

Yet another significant aspect and feature of the present invention is a reduced radius shaft maximally sized to provide for suitable robustness.

A still further significant aspect and feature of the present invention is a collapsible safety rail system which can incorporate other rail sections, latching posts, gate posts, or related devices, some or all or none of which can include a pivot assembly.

Yet another significant aspect and feature of the present invention is a reduced radius shaft having a semispherical-shaped end to provide for suitable robustness.

Another significant aspect and feature of the present invention is a collapsible safety rail system which is portable.

Another significant aspect and feature of the present invention is a collapsible safety rail system which is portable, but which can be permanently mounted.

Yet another significant aspect and feature of the present invention is a collapsible safety rail system which uses heavy bases to provide for overall stability and robustness.

A still further significant aspect and feature of the present invention is a collapsible safety rail system which can be freestanding, but which can be permanently secured to a suitable mounting surface or structure utilizing mounting hardware extending through holes in the bases, if desired.

A still further significant aspect and feature of the present invention is a collapsible safety rail system having bases which are user-friendly for the purposes of manual handling, and which are stackable.

Having thus briefly described embodiments of the present invention and having mentioned some significant aspects and features of the present invention, it is the principal object of the present invention to provide a collapsible safety rail system.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is an isometric view showing the use and structure of the collapsible safety rail system, the present invention;

FIG. 2 is an exploded view of a pivot assembly in relationship to the lower portion of an end post;

FIG. 3 is an assembled view of the pivot assembly connected to the lower portion of the end post;

FIG. 4 is a front view of the assembled components of FIG. 3 with the lower portion of the end post depicted in phantom;

FIG. 5 is a cross section view of the pivot assembly substantially along line 5-5 of FIG. 4 showing the mounting fixture and connected end post pivoted about the pivot pin to position the end post of the collapsible safety rail assembly to provide for minimum viewable profile;

FIG. 6 is a cross section view of the pivot assembly along line 6-6 of FIG. 4;

FIG. 7 is an isometric view of a base;

FIG. 8 shows a pivot assembly and a portion of an attached end post aligned vertically in the post receiver prior to pivoting of the mounting fixture and attached end post;

FIG. 9 illustrates the pivoting of the mounting fixture and attached end post to and beyond the horizontal position during positioning of a collapsible safety rail assembly;

FIG. 10, an alternative embodiment, is an exploded view of a pivot assembly in alignment with an end post;

FIG. 11 is an assembled view of elements of FIG. 10; and,

FIG. 12 is a cross section view of a pivot assembly substantially along line 12-12 of FIG. 11.

### DETAILED DESCRIPTION OF THE PREFERRED EMBODIMENTS

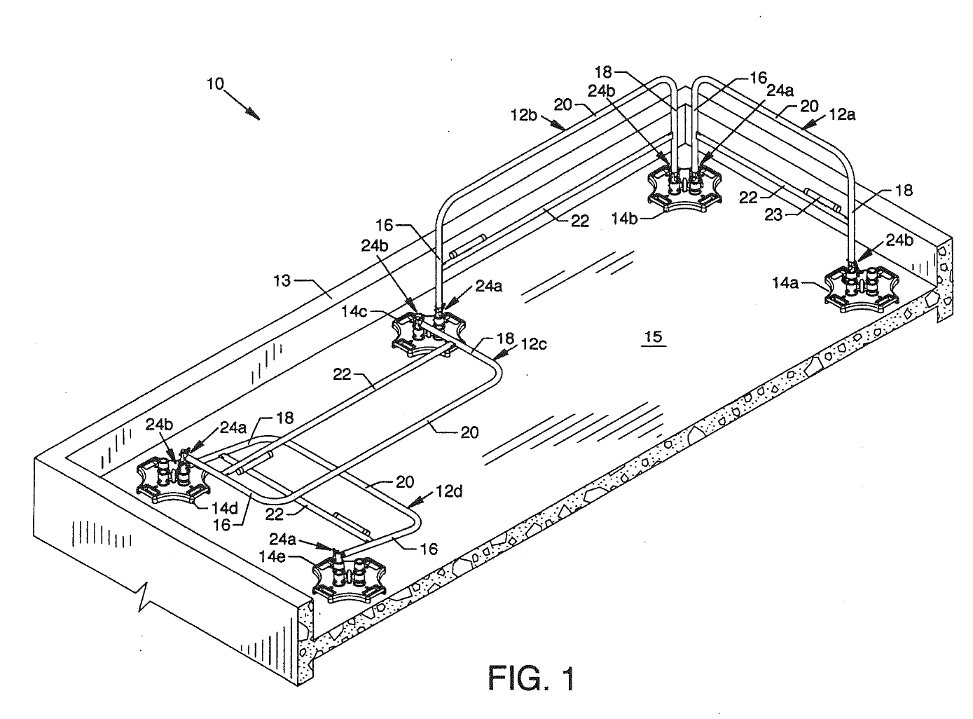

FIG. 1 is an isometric view of the collapsible safety rail system 10, the present invention, including a plurality of similarly constructed collapsible safety rail assemblies 12a-12d and a plurality of bases 14a-14e of substantial weight and size, each connectively associated with one or more collapsible safety rail assemblies 12a-12d. For purposes of illustration and example, the collapsible safety rail system 10 is shown in use for protection along the edge of a wall section 13 extending above the top surface of a roof 15 where the collapsible safety rail system 10 is shown partially in the protective mode and partially in the collapsed mode. Collapsible safety rail assemblies 12a and 12b are shown in the protective mode of operation being vertically erected with respect to the bases 14a-14c for prevention of access across the collapsible safety rail assemblies 12a and 12b. Collapsible safety rail assemblies 12c and 12d are shown in the collapsed mode of operation being substantially horizontally oriented with respect to the bases 14c-14e to provide for minimum viewable profile.

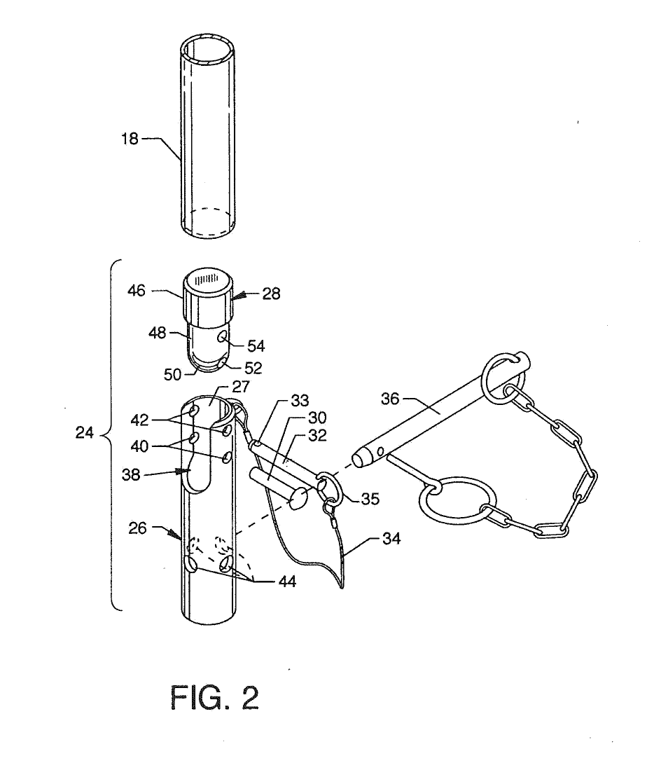

The similarly constructed collapsible safety rail assemblies 12a-12d each includes opposed left and right end posts 16 and 18, a top horizontal rail 20 extending from the left end post 16 to the right end post 18, and a bottom horizontal rail 22 extending between the left end post 16 and the right end post 18. An accessible instruction storage tube 23 is located on each bottom horizontal rail 22. Individual pivot assemblies designated 24a and 24b, as described in detail as pivot assembly 24 in FIG. 2, are located at the ends of the left and right end posts 16 and 18 nearest the bottom horizontal rail 22, respectively, of each of the collapsible safety rail assemblies 12a-12d. A slotted tubular base 26 (FIG. 2), which is stationary, is located at the lower region of each of the pivot assemblies 24a and 24b and secures in the bases 14a-14e, as later described in detail.

FIG. 2 is an exploded view of the pivot assembly 24, multiply designated as pivot assemblies 24a and 24b in FIG. 1, in relationship to the lower portion of an end post 18. The pivot assembly 24 has major structural components including a stationary slotted tubular base 26 and a pivotable multi-radius mounting fixture 28, and also includes a pivot pin 30 and a detent pin 32 having a spring-loaded ball 33, the latter of which is secured to the slotted tubular base 26 by a lanyard 34 and ring 35. Also shown is another locking pin 36 including suitable hardware for securing of the pivot assembly 24 to one of the bases 14a-14e.

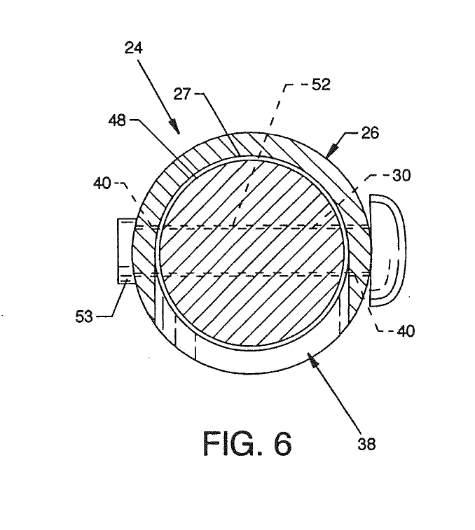

The slotted tubular base 26 includes a slot 38 in vertical orientation intersecting the wall of the slotted tubular base 26 at the upper region of the slotted tubular base 26. Opposed pivot pin holes 40 extend through the upper region of the slotted tubular base 26 for accommodation of the pivot pin 30, and opposed detent pin holes 42 aligned above the opposed pivot pin holes 40 extend through the upper region of the slotted tubular base 26 for accommodation of the detent pin 32. Four or another suitable number of locking pin holes 44 extend through the lower region of the slotted tubular base 26 for accommodation of the locking pin 36 when securing the pivot assembly 24 to a base 14a-14e. The multi-radius mounting fixture 28 includes a round end post mount 46 and a round reduced radius shaft 48 having a semispherical-shaped end 50 extending from the end post mount 46. The radius of the reduced radius shaft 48 is nearly as large as the radius of an inside surface 27 (see also FIG. 6) of the slotted tubular base 26. Such a relationship allows for robustness and maximizes the structural integrity of the mounting fixture 28 by providing sufficient structural mass about a pivot pin hole 52 extending through the lower portion of the reduced radius shaft 48. The pivot pin hole 52 accommodates the pivot pin 30, and a detent pin hole 54 aligned above the pivot pin hole 52 extends through the upper portion of the reduced radius shaft 48 for accommodation of the detent pin 32.

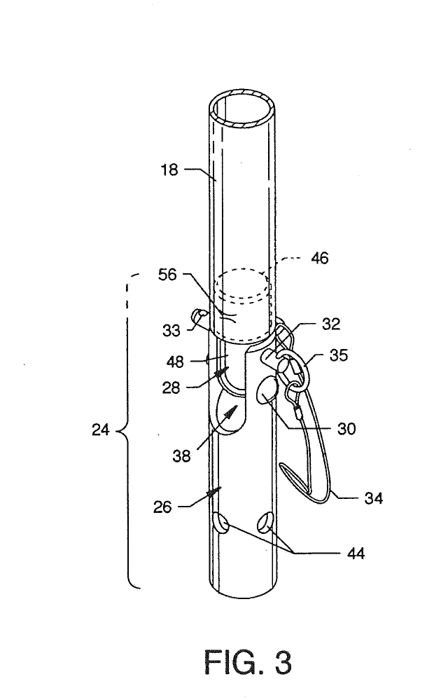

FIG. 3 is an assembled view of the pivot assembly 24 attached to the lower portion of the end post 18. The end post mount 46 can be a close tolerance fit for suitable accommodation by the lower portion of the end post 18 and can be secured therein such as by swaging the end post 18 at one or more locations, such as is shown by one or more swages 56, or by other suitable methods, such as, but not limited to, welding, press fitting, the use of fasteners, and the like. The reduced radius shaft 48 is shown aligned vertically within the top region of the slotted tubular base 26 and secured therein by the pivot pin 30 which extends through the opposed pivot pin holes 40 in the slotted tubular base 26 and through the pivot pin hole 52 in the reduced radius shaft 48 and by the detent pin 32 which extends through the opposed detent pin holes 42 in the slotted tubular base 26 and through the detent pin hole 54 in the reduced radius shaft 48.

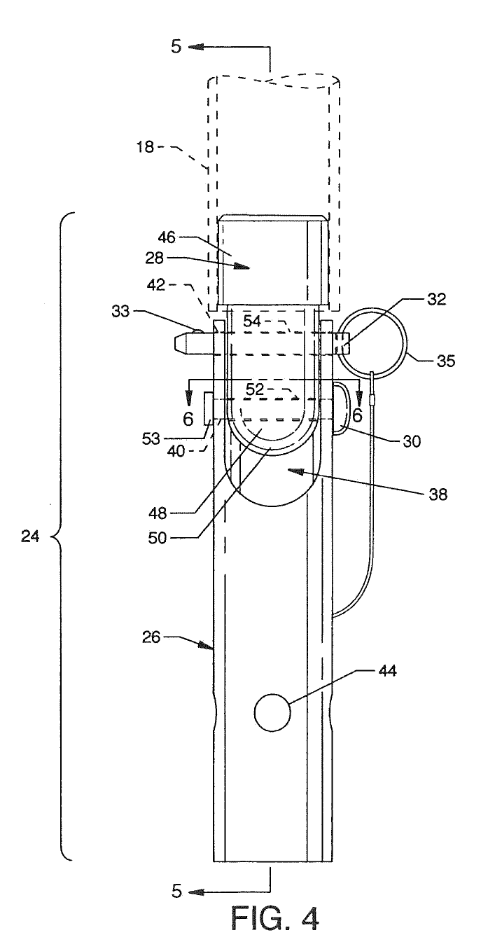

FIG. 4 is a front view of the assembled components of FIG. 3 with the lower portion of the end post 18 depicted in phantom. Shown in particular is the accommodation of the pivot pin 30 and of the detent pin 32, as described with reference to FIG. 2. One end of the pivot pin 30 is peened over at 53 to permanently maintain the position of the pivot pin 30. The spring-loaded ball 33 maintains the position of the detent pin 32 to ensure the upright positioning of the end post 18 when the collapsible safety rail assemblies 12a-12d are in the upright position.

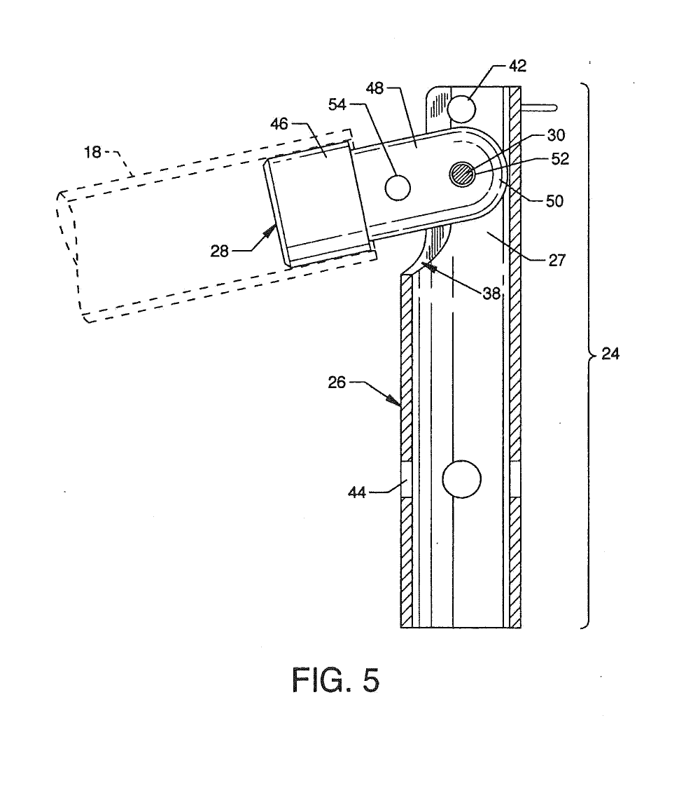

FIG. 5 is a cross section view of the pivot assembly 24 substantially along line 5-5 of FIG. 4 showing the mounting fixture 28 and connected end post 18 (and 16) pivoted about the pivot pin 30 such as to position the end posts 18 of the collapsible safety rail assemblies 12c-12d, as shown in FIG. 1, to provide for minimum viewable profile. The semispherical-shaped end 50 of the reduced radius shaft 48 is easily accommodated by and maintains clearance with the inside surface 27 of the slotted tubular base 26 to permit sufficient rotation of the mounting fixture 28 therein, as there is no interfering or conflicting geometry. The vertical dimension of the slot 38 is of sufficient length to allow rotation of the mounting fixture 28 below the horizontal aspect to allow the top horizontal rail 20 of the collapsible safety rail assemblies 12c-12d to contact and rest upon the general horizontal surface upon which the collapsible safety rail system 10 is utilized.

FIG. 6 is a cross section view of the pivot assembly 24 along line 6-6 of FIG. 4. Shown in particular is the relationship of the reduced radius shaft 48 to the interior surface 27 of the slotted tubular base 26, wherein clearance is provided for pivotal rotation therein.

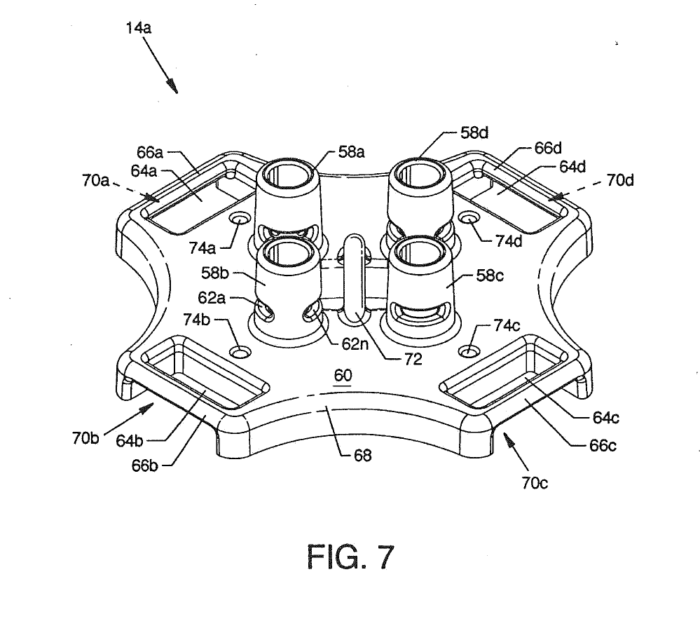

FIG. 7 is an isometric view of the base 14a, one of the identical bases 14a-14e according to the present invention. The bases 14a-14e can weigh between 100-120 pounds for purposes of example, and can be of cast iron or welded plate and tube to support safety rail sections or assemblies without tipping. The identically constructed bases 14a-14e include four post receivers 58a-58d which extend perpendicularly and upwardly from planar top portion or surface 60, any of which can appropriately accommodate the left or right end posts 16 and 18 of the collapsible safety rail assemblies 12a-12d, as well as other suitably fashioned components, such as, but not limited to, unshown latching posts, gate posts, or locking couplers, which can also include one or more pivot assemblies 24. Each of these post receivers 58a-58d includes a plurality of horizontally aligned pin receivers, such as slots 62a-62n, best shown on post receiver 58b. Left and right end posts 16 and 18 of the collapsible safety rail assemblies 12a-12d, as well as other suitably fashioned components, such as, but not limited to, unshown latching posts, gate posts, or locking couplers, all incorporate the plurality of locking pin holes 44 (FIG. 2) for receiving locking pins 36 (FIG. 2) to hold the left and right end posts 16 and 18 of the collapsible safety rail assemblies 12a-12d, as well as other suitably fashioned components, such as, but not limited to, unshown latching posts, gate posts, or locking couplers in place in the post receivers 58a-58d of the bases 14a-14e. The left or right end posts 16 and 18 of the collapsible safety rail assemblies 12a-12d or other suitably fashioned components, such as, but not limited to, unshown latching posts, gate posts, or locking couplers, are secured to the post receivers 58a-58d of one or more individual bases 14a-14e by the use of locking pins 36 extending through opposed locking pin holes 44 and the slots 62a-62n. Such a relationship allows the left or right end posts 16 and 18 of the collapsible safety rail assemblies 12a-12n, as well as other suitably fashioned components, such as, but not limited to, unshown latching posts, gate posts, or locking couplers, to pivot as required about the vertical axes of the post receivers 58a-58d. In the alternative, a base 14a-14e can also be pivoted about the lower region of a left or right post 16 and 18, respectively, in order to align and utilize other post receivers 58a-58d or other suitably fashioned components. Each base 14a-14e may accommodate a maximum of four of the following components in various combinations: left and right end posts 16 and 18 of the collapsible safety rail assemblies 12a-12d and other suitably fashioned components, such as, but not limited to, unshown latching posts, gate posts, or locking couplers. Each can be locked in any position within its range of motion about a vertical axis by various utilizations of the holes 44, the pin receivers in the form of slots 62a-62n, and the locking pins 36, all of which together constitute locking means or means for locking the various posts or other suitably fashioned components to the post receivers. It is to be understood that the slots 62a-62n may be replaced with multiple holes at different heights to accommodate other variously located holes in the lower region of a post, but holes will not allow the infinite 360 degree range in which the left or right end posts 16 and 18, as well as other suitably fashioned components, such as, but not limited to, unshown latching posts, gate posts, or locking couplers, can be angularly oriented and locked. It is also to be understood that slots, such as slots 62a-62n, can be included at other levels along and about the post receivers 58a-58d, as well as at various locations about the circumferences of the post receivers 58a-58d, to maintain 360 degree positionable capabilities of any member which engages the interior of the post receivers 58a-58d.

The bases 14a-14e include cutouts 64a-64d, whereby handling of the bases 14a-14e is readily facilitated in a manual fashion. Each base 14a-14e is constructed in the same manner having identical parts including the planar top portion or surface 60 with cutouts 64a-64d on four opposing sides creating built-in recessed handles 66a-66d for manual transporting or lifting of the bases 14a-14e. The bases 14a-14e include a continuous curved or radiused upper edge 68 about the planar top portion or surface 60. The recessed handles 66a-66d are fashioned to accommodate manual handling and include features making the gripping of the recessed handles 66a-66d accessible and comfortable. The upper and outer regions of the recessed handles 66a-66d are formed by portions of the curved or radiused upper edge 68, and the remaining edges forming the recessed handles 66a-66d have edges which are curved or radiused to eliminate any edges which could prove to be uncomfortable given the weight of the bases 14a-14e. It is to be appreciated that all of the upper edges of the cutouts 64a-64d are curved or radiused. Downwardly extending recesses 70a-70d beneath the recessed handles 66a-66d provide for manual access under the recessed handles 66a-66d without first lifting the bases 14a-14e. There is also a centrally located lifting bar 72 which allows the user to hook the bases 14a-14e to a pulley, a dolly, or other labor saving device to more easily move the heavy bases 14a-14e. There are provided holes 74a-74d which can accommodate anchor bolts for securing the bases 14a-14e to a work surface, such as a concrete floor or roof top, if permanent mounting is desired.

Stacking recesses (not shown) are recessed into a planar bottom surface of the bases 14a-14e which align with the upper regions of other post receivers 58a-58d extending from the planar top portion or surface 60. The stacking recesses are utilized for stacking or storage of bases 14a-14e when not in use. Also included are drain holes (not shown) extending through the bases 14a-14e and co-located between the post receivers 58a-58d and the stacking recesses.

### Mode of Operation

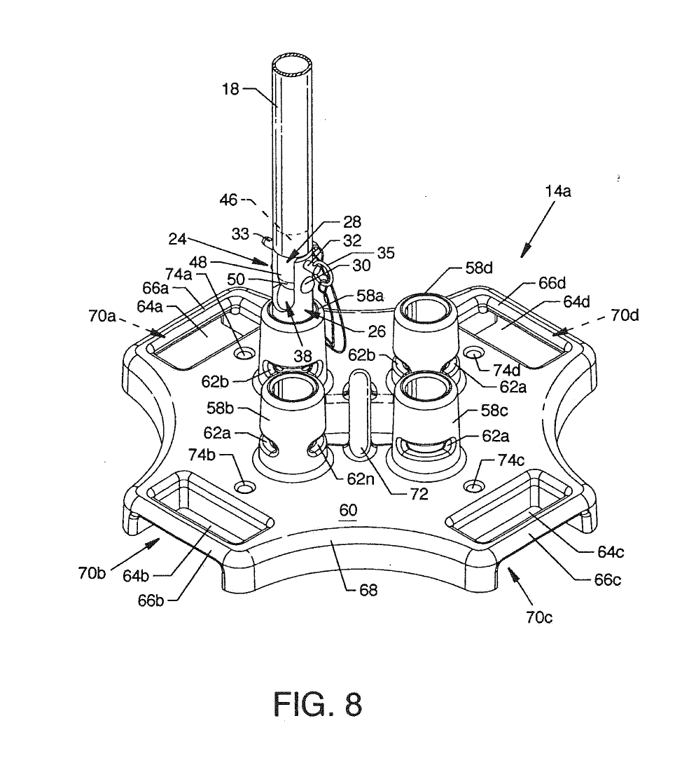

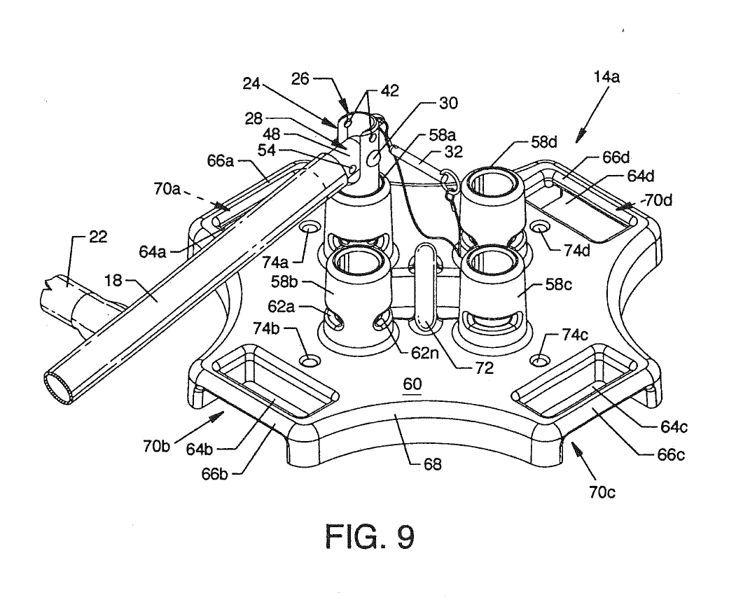

FIGS. 8 and 9 best illustrate the mode of operation. FIG. 8 shows a pivot assembly 24 and a portion of an attached end post 18 aligned vertically in the post receiver 58a prior to pivoting of the mounting fixture 28 and attached end post 18 (and 16), as well as the rest of a collapsible safety rail assembly 12c-12d to the collapsed position in a fashion shown in FIG. 1; and FIG. 9 illustrates the pivoting of the mounting fixture 28 and attached end post 18 to and beyond the horizontal position. The locking pin 36 is not shown engaged in the locking position for purposes of brevity.

In FIG. 8, the detent pin 32 and the pivot pin 30 engage both the slotted tubular base 26 and the mounting fixture 28 of the pivot assembly 24, and the pivot assembly 24 engages the post receiver 58a of the base 14a. Such an arrangement causes the mounting fixture 28 and connected end post 18 to maintain a vertically oriented position, thereby keeping a collapsible safety rail assembly 12a-12b in the erect and protective mode of operation.

In FIG. 9, the detent pin 32 is shown disengaged from the holes 42 of the slotted tubular base 26 and from the detent pin hole 54 of the reduced radius shaft 48 to allow pivoting of the mounting fixture 28 about the co-located pivot pin hole 52 of the reduced radius shaft 48 and the pivot pin 30. Such pivoting allows repositioning of the mounting fixture 28 and connected end post 18 of a collapsible safety rail assembly 12c-12d to a collapsed and minimum viewable profile position, as shown in FIG. 1. Understandably, parallel operation and manipulation at another of the bases 14a-14e at the other end of an associated collapsible safety rail assembly 12c-12d would occur simultaneously to allow such repositioning of a collapsible safety rail assembly 12c-12d. Erection of the collapsible safety rail assembly 12c-12d is accomplished in reverse order. The use of pivot assemblies 24 can also be incorporated into use with the post receivers 58a-58d of the bases 14a-14d to provide for collapsing of other related structures, such as, but not limited to, unshown latching posts, gate posts, and the like.

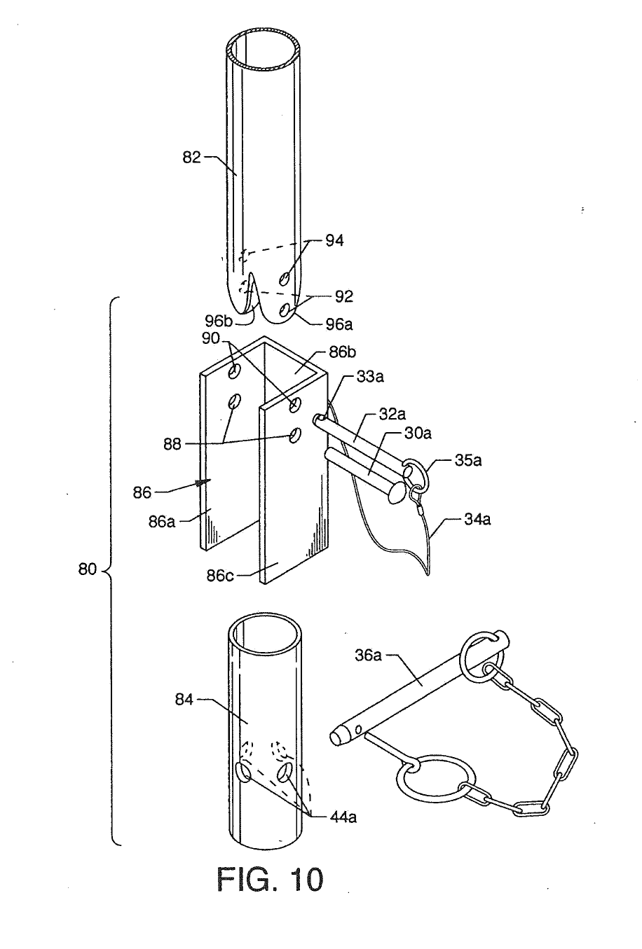

FIG. 10, an alternative embodiment, is an exploded view of a pivot assembly 80 which could be utilized in lieu of pivot assemblies 24a and 24b of FIG. 1 shown in relationship to the lower region of an end post 82 which can be utilized in lieu of end post 18 (and 16) to, in part, form collapsible safety rail assemblies generally similar to collapsible safety rail assemblies 12a-12d. The pivot assembly 80 has major structural components including a stationary tubular base 84 and a vertically aligned mounting fixture 86 resembling a channel having panels 86a, 86b and 86c. Opposed pivot pin holes 88 extend through the upper region of the panels 86a and 86c, respectively. A pivot pin 30a extends through the opposed pivot pin holes 88a. A detent pin 32a is secured to the mounting fixture 86 by a lanyard 34a and ring 35a. Opposed detent pin holes 90 align above the opposed pivot pin holes 88 and extend through the upper regions of the panels 86a and 86c, respectively, for accommodation of the detent pin 32a. The detent pin 32a includes a spring-loaded ball 33a. Also shown is another locking pin 36a including suitable hardware for securing of the pivot assembly 80 to one of the bases 14a-14e.

The end post 82 includes opposed pivot pin holes 92 at the lower edge thereof and opposed detent pin holes 94 aligned above the opposed pivot pin holes 92. The lower portion of the end post 82 includes radiused edges 96a and 96b which accommodate rotation of the lower region of the end post 82 to provide clearance with the panel 86b at the rear of the mounting fixture 86.

The tubular base 84 includes locking pin holes 44a which extend through the lower region of the tubular base 84 for accommodation of the locking pin 36a when securing the pivot assembly 80 to a base 14a-14e. The radius of the tubular base 84 and of the end post 82 is nearly as large as the distance between inside surfaces of the panels 86a and 86c of the mounting fixture 86. Such a relationship allows for robustness and maximizes the structural integrity about the mounting fixture 86 by providing sufficient structural mass about the opposed pivot holes 92 extending through the lower portion of the end post 82. The opposed pivot holes 92 accommodate the pivot pin 30a and the opposed detent pin holes 94 provide for accommodation of the detent pin 32a.

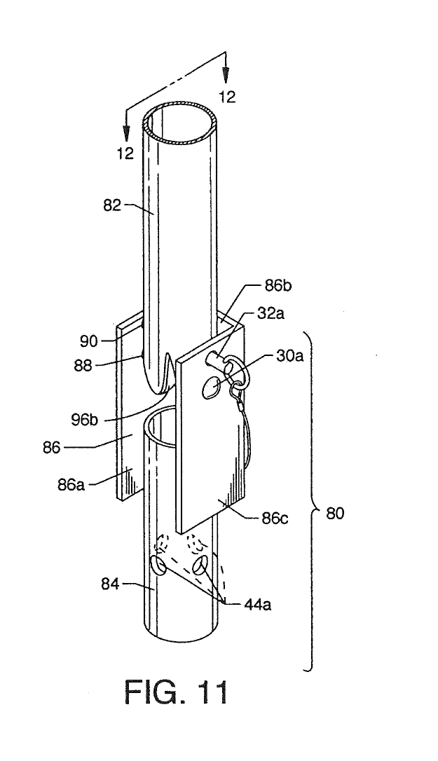

FIG. 11 is an assembled view of elements of FIG. 10 where the tubular base 84 is attached to the mounting fixture 86, such as by welding, riveting, the use of fasteners, or other suitable methods. The tubular base 84 attaches to the bases 14a-14e by use of the locking pin 36a in a manner previously described. The end post 82 secures to the mounting fixture 86 by the use of the pivot pin 30a which extends through the opposed pivot pin holes 88 of the mounting fixture 86 and the opposed pivot pin holes 92 of the end post 82 and is peened over to secure therein. The detent pin 32a assists in securing of the end post 82 to the mounting fixture 86. The detent pin 32a extends through the opposed detent pin holes 90 of the mounting fixture 86 and through the opposed detent pin holes 94 of the end post 82 and is secured therein by the spring-loaded ball 33a.

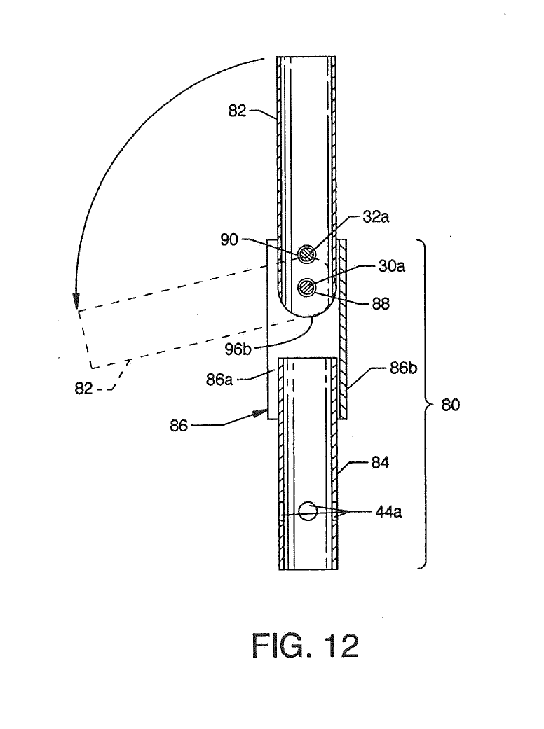

FIG. 12 is a cross section view of the pivot assembly 80 substantially along line 12-12 of FIG. 11 showing the relationship of the mounting fixture 86, the attached end post 82, and the attached tubular base 84. The end post 82 is pivoted about the pivot pin 30a as shown in dashed lines to position the end post 82 in the same manner shown for the collapsible safety rail assemblies 12c-12d as illustrated in FIG. 1, to provide for minimum viewable profile. The radiused edges 96a and 96b of the end post 82 are easily accommodated by and maintain clearance with the panel 86b of the mounting fixture 86 to permit sufficient rotation of the end post 82 within mounting fixture 86, as there is no interfering or conflicting geometry. The vertical spacing between the top of the tubular base 84 and the end post 82 is of sufficient dimension to allow rotation of the end post 82 below the horizontal aspect to allow the top horizontal rail of the collapsible safety rail assemblies which are generally similar to collapsible safety rail assemblies 12a-12d to contact and rest upon the general horizontal surface upon which the collapsible safety rail system 10 is utilized.

Operation of the alternative embodiment is similar in many fashions to the operation of the preferred embodiment. The detent pin 32a is removed to allow pivoting of the end post 82 about the pivot pin 30a in order to maneuver a collapsible safety rail assembly similar in most respects to the collapsible safety rail assemblies 12a-12d.

Various modifications can be made to the present invention without departing from the apparent scope hereof.

1-16. (canceled)

17. A collapsible and free-standing safety rail system, the system comprising:
a base for supporting at least one vertical post, the base comprising:
a top surface;
a bottom surface;
a plurality of opposed cutouts distributed on the base, each cutout extending between the top surface to the planar bottom surface, each cutout defining a handle, and wherein the handles have an opposed relationship to each other; and
at least one tubular aperture extending upwardly from the planar top surface of the base; and
at least one removable pivot assembly, the pivot assembly comprising:
a tubular section having a lower end insertable into the tubular aperture and an upper end of the tubular section comprising an upper bracket portion;
a mounting connection wherein the mounting connection is pivotably secured to the tubular section and the mounting connection having an upper and a lower end wherein the upper end is adapted for vertical connection to the vertical post and the lower end is adapted for pivotable connection with the upper bracket portion of the tubular section;
a pivot pin for pivotably securing the mounting connection to the tubular section; and
a locking pin for vertically securing the mounting connection to the tubular section.

18. The system of claim 17 wherein the upper bracket portion comprises a pair of opposing walls, each opposing wall adapted with a first and a second aperture such that the pair of opposing walls of the upper bracket portion comprises a first and a second pair of opposing apertures.

19. The system of claim 18 wherein the lower end of the mounting connection comprises a first opening for insertion of the locking pin through the lower end of the mounting connection and second opening for insertion of the pivot pin through the lower end of the mounting connection.

20. The system of claim 19 wherein the pivot assembly further comprises securing the mounting connection to the tubular section by placement of the lower end of the mounting connection between the opposing walls of the upper bracket portion and further pivotably securing the mounting connection to the tubular section by insertion of the pivot pin through the second pair of apertures in the bracket portion and through the second opening in the mounting connection.

21. The system of claim 20 and further vertically securing the mounting connection to the tubular section by insertion of the locking pin through the first pair of apertures in the bracket portion and through the first opening in the mounting connection.

22. The system of claim 21 wherein the first pair of apertures for receiving the locking pin is positioned vertically above the second pair of apertures for receiving the pivot pin in the mounting connection.

23. The system of claim 17 wherein the lower end of the tubular section further comprises at least one pair of opposing apertures for securing the tubular section vertically in the tubular aperture.

24. The system of claim 23 wherein the tubular section is inserted into the tubular aperture and secured vertically to the base by insertion of a pin horizontally into and through the pair of opposing apertures.

25. The system of claim 17 wherein the upper end of the mounting connection is insertable into an opening in the base of the vertical post to secure the vertical post to the mounting connection such that the vertical post is pivotable with the mounting connection about the pivot pin.

26. The system of claim 25 wherein the vertical post and mounting connection are pivotable between a first position being vertical with respect to the tubular section and a second position being horizontal with respect to the tubular section.

27. The system of claim 17 and further comprising a frame wherein the frame comprises the vertical post, a second vertical post parallel to the vertical post and a horizontal post connecting the vertical post and the second vertical post by extending there between.

28. The system of claim 27 and further comprising a second base positionable a distance from the base, the distance being substantially equal to the length of the horizontal post, and the second vertical post being pivotably secured to the second base in substantially the same manner as the first vertical post is secured to the base.
